(19) United States
(12) Patent Application Publication
(10) Pub. No.: US 2008/0031590 A1
(43) Pub. Date: Feb. 7, 2008

(54) DIGITAL VIDEO RECORDING OF MULTIPLE ASSOCIATED CHANNELS

(76) Inventor: Charles J. Kulas, San Francisco, CA (US)

Correspondence Address: CHARLES J. KULAS, 651 ORIZABA AVE., SAN FRANCISCO, CA, 94132, US

(21) Appl. No.: 11/677,573

(22) Filed: Feb. 21, 2007

Related U.S. Application Data
(63) Continuation-in-part of application No. 11/499,315, filed on Aug. 4, 2006.

(51) Int. Cl. H04N 5/91

(52) U.S. Cl. 386/92

(57) ABSTRACT

Multiple associated video channels are recorded by a digital video recorder so that during playback a user can select among the channels while channel playback synchronization is maintained. A cable television set-top box application allows a primary channel to have secondary channels associated with the primary channel. The secondary channels include substantially the same program content as the primary channel but also include additional information such as tags having text descriptions of objects shown in the program's video. By selecting either the primary or a secondary channel a viewer has the appearance of the tags being turned on or off while the continuity of the program presentation is maintained.

### CLAIM OF PRIORITY

This application is a continuation-in-part of U.S. patent application Ser. No. 11/499,315 filed on Aug. 4, 2006 entitled “DISPLAYING TAGS ASSOCIATED WITH ITEMS IN A VIDEO PLAYBACK” which is hereby incorporated by reference as if set forth in full in this application for all purposes.

### SUMMARY OF EMBODIMENTS OF THE INVENTION

In a preferred embodiment, multiple associated video channels are recorded by a digital video recorder so that during playback a user can select among the channels while channel playback synchronization is maintained. A cable television set-top box application allows a primary channel to have secondary channels associated with the primary channel. The secondary channels include substantially the same program content as the primary channel but also include additional information such as tags having text descriptions of objects shown in the program's video. By selecting either the primary or a secondary channel a viewer has the appearance of the tags being turned on or off while the continuity of the program presentation is maintained.

Embodiments of the invention provide a method, apparatus and instructions in a machine-readable storage medium for A method for recording multiple associated channels of video content, the method comprising: accepting a signal from a user input device to select a first channel of first video content; determining that a second channel having second video content is associated with the first channel; detecting a signal to store the first video content; and storing the first and second video content in response to the signal to store the first video content.

### BRIEF DESCRIPTION OF THE DRAWINGS

FIG. 1 shows an example of a prior art video display including an image frame;

FIG. 2 shows the frame of FIG. 1 including tags in a Gadget category;

FIG. 3 shows the frame of FIG. 1 including tags in a Style category;

FIG. 4 shows the frame of FIG. 1 including tags in a Scene category;

FIG. 5 shows an original sequence and two corresponding tag sequences;

FIG. 6 shows a DVD player system suitable for use with the present invention;

FIG. 7 illustrates multiple sequences of video including tag sequences;

FIG. 8 shows an example of still-frame tag sequences;

FIG. 9 illustrates details of a visual presentation system including video recording; and

FIG. 10 illustrates multiple stream recording.

### DETAILED DESCRIPTION OF EMBODIMENTS OF THE INVENTION

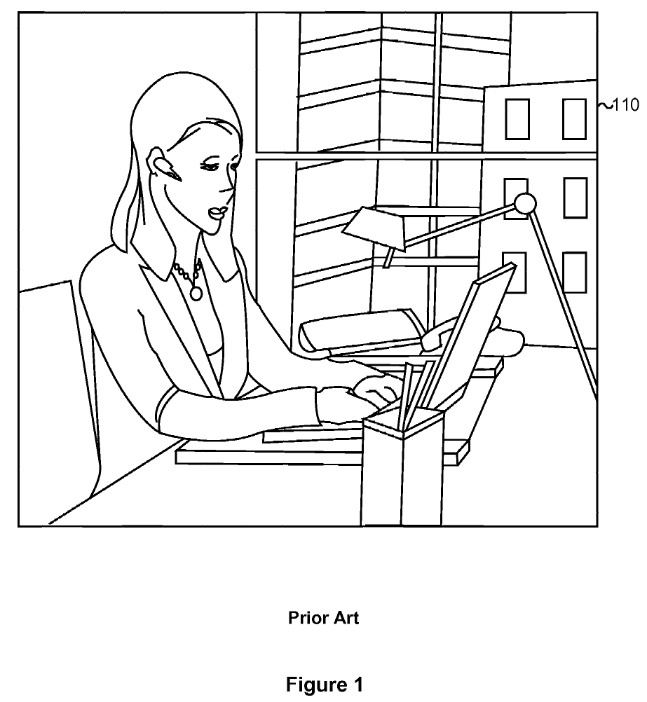

FIG. 1 illustrates a prior art video display. In FIG. 1, display 110 includes a typical image. In this case the image is of a woman in an office typing at a laptop at her desk while she is also talking on a wireless phone. The video plays with animation and sounds as is known in the art although only a single image frame from the video is shown in FIG. 1. Although embodiments of the invention are discussed primarily with respect to video presentations, any type of visual presentation can be adapted for use with the present invention. For example, animations, movies, pre-stored files, slide shows, Flash™ animation, etc. can be used with features of the invention.

Any type of playback device (e.g., computer system, set-top box, DVD player, etc.), image format (Motion Picture Experts Group (MPEG), Quicktime™, audio-visual interleave (AVI), Joint Photographic Experts Group (JPEG), motion JPEG, etc.), display method or device (cathode ray tube, plasma display, liquid crystal display (LCD), light emitting diode (LED) display, organic light emitting display (OLED), electroluminescent, etc.). Any suitable source can be used to obtain playback content such as a DVD, HD DVD, Blue-Ray™ DVD, hard disk drive, video compact disk (CD), fiber optic link, cable connection, radio-frequency transmission, network connection, etc. In general, the audio/visual content, display and playback hardware, content format, delivery mechanism and other components and properties of the system can vary, as desired, and any suitable items and characteristics can be used.

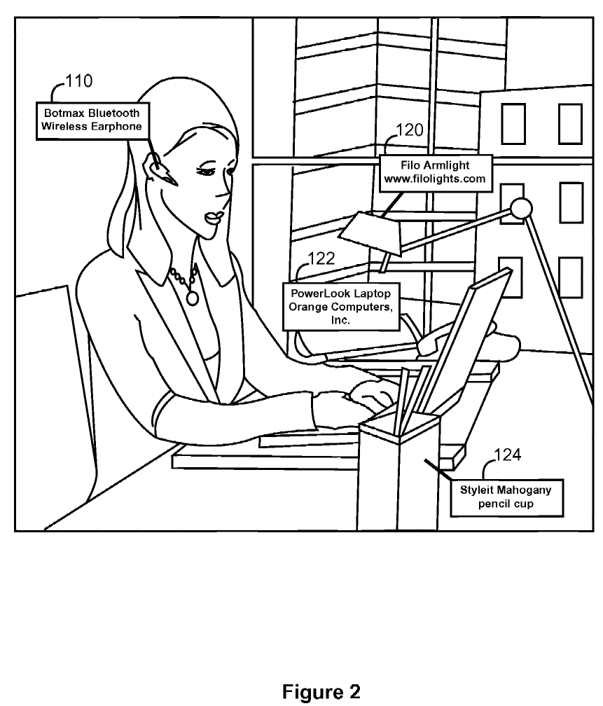

FIG. 2 shows the display of FIG. 1 with tags added to the image. In a preferred embodiment, a user can select whether tags are displayed or not by using a user input device. For example, if the user is watching a video played back on a television via a DVD player or a cable box then the user can press a button on a remote control device to cause the tags to be displayed on a currently running video. Similarly, the user can deselect, or turn off, the tag display by depressing the same or a different button. If the user is watching video playback on a computer system a keyboard keypress can cause the tags to turn on or off. Or a mouse selection of an on-screen button or command can be used. Other embodiments can use any other suitable control for invoking tag displays. Displaying of tags can be automated as where a user decides to watch a show without tags for a first time and then automatically replay the show with tags a second time.

In FIG. 2, each tag is shown with a text box and lead line. The text box includes information relevant to an item that is pointed at by the lead line. For example, tag 110 states “Botmax Bluetooth Wireless Earphone” with a lead line pointing to the earphone that is in the ear of the woman who is the subject of the scene. Thus, a viewer who is interested in such things can obtain enough information from the tag to find a seller of the earphone. Or the viewer can do an online search for the earphone by manufacturer and/or model name and can obtain more information about the earphone as research prior to making a purchase.

Other tags such as 120, 122 and 124 provide information about other items in the frame. Tag 120 states “Filo Armlight www.filolights.com” to point out the manufacturer (“Filo”) and model (“Armlight”) and website (www.filolights.com) relating to the light to which tag 120 is connected via its lead line. Tags can include any type of interesting or useful information about an item or about other characteristics of the image frame or video scene to which the image frame belongs.

Tag 122 points to the laptop on which the woman is typing and states “PowerLook Laptop/Orange Computers, Inc.” This shows the model and manufacturer of the laptop. Tag 124 points to the pencil holder and reads “StyleIt Mahogany pencil cup.” Note that more, less or different information can be included in each tag, as desired, by the company that is managing the tag advertising (“tagvertising”) of the particular video content.

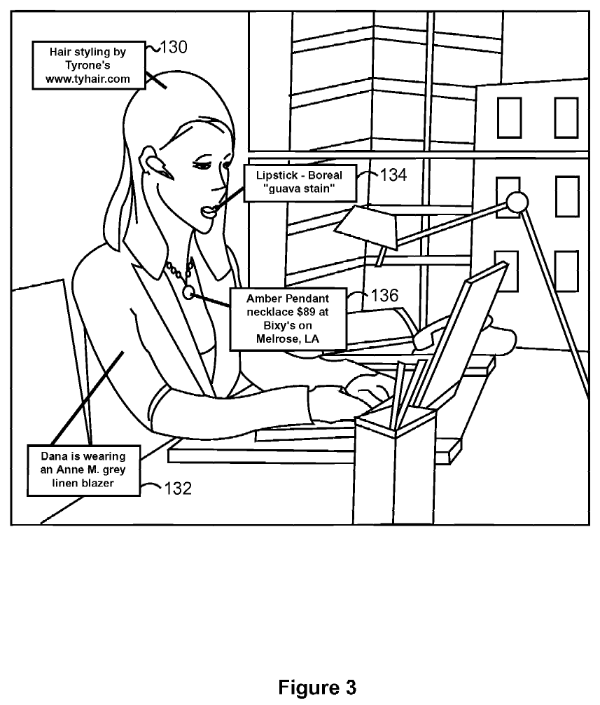

FIG. 3 shows additional types of items that can be tagged. In FIG. 2, the tagged items are in a “gadget” category of electronic items or physical useful objects. FIG. 3 shows a second category of “style.” In this category, items such as apparel, fashion accessories, jewelry, hairstyles, makeup colors, interior decorating colors and designs, fabric types, architecture, etc. are described by information provided by tags.

Tag 130 relates to the woman's hair styling and states the hairdresser's name and website for information about the salon. Tag 132 describes the jacket designer and fabric. Tag 134 shows a cosmetics manufacturer and color of the lipstick that the woman is wearing. Tag 136 describes the material, style, price and reseller relating to the necklace.

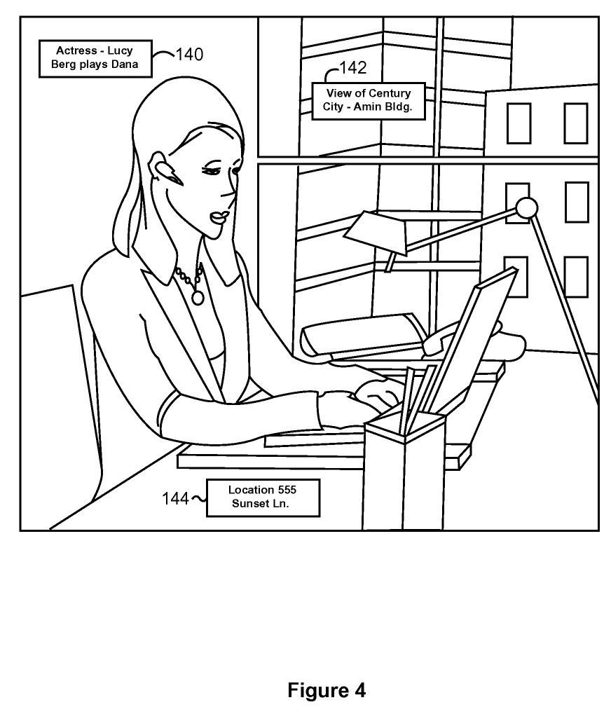

In FIG. 4, another category of tags relating to the “scene” is displayed. Tag 140 describes the actress and character being played, tag 142 describes what is being seen through the window, and tag 144 shows the location of where this scene was shot. Other information relating to the scene can be provided such as time of day, type of lighting used to light the set, type of camera and camera setting used to capture the image, the name of the director, screenwriter, etc.

Tag designs can vary and can use any suitable design property. Usually it is desirable to have the tags be legible and convey a desired amount of information while at the same time being as unobtrusive as possible so that viewing of the basic video content is still possible. Different graphics approaches such as using colors that are compatible with the scene yet provide sufficient contrast, using transparent or semi-transparent windows, etc. can be employed. Tag placement can be chosen so that the tag overlays areas of the video that are less important to viewing. For example, a blank wall could be a good placement of a tag while an area over a character's face would usually not be a good placement.

Tag shape, color, position, animation and size are some of the tag characteristics that can be modified. Many different factors can affect these tag characteristics. If a specific factor, such as aesthetics, is given priority then a graphic artist or scene coordinator can be used to match the look and behavior of tags to a theme of a scene or overall presentation. For example, where a scary movie is tagged, the tag design can be in darker colors with borders having cobwebs, blood, ritual symbols, etc. For a science fiction episode, the tags can be made to look futuristic.

If an advertising factor is given priority then tags from a preferred sponsor (e.g., someone who is paying more for advertising) can be presented in bolder text, brighter colors, made larger or made to overlap on top of other tags, etc.

In general, any of the tag characteristics can be modified in accordance with one or more factors.

As the scene changes, such as when characters or objects move through or within a scene, when the camera changes angles, when there is a cut to another scene, etc., tags can also change according to a tag behavior. Different tag behaviors can be used to achieve objectives of conveying information associated with an item while still allowing viewing of the video. One behavior is to minimize the movement of a tag's text while still allowing the tag to “point” to the item. This can be accomplished by keeping the tag's text stationary with one end of the lead line connecting to the text box and the other end following a moving item to which the text relates.

Another tag behavior is to shrink or enlarge a tag's text box according to the relative size of the item associated with the tag. For example, if an item is in the foreground then the tag's text area can be larger. As the item moves farther from the camera and becomes smaller then the tag can become smaller and can eventually be removed from the screen. The manner of shrinking the text area can include making the actual text smaller, removing text from the display while retaining other text, replacing the text with alternative text, etc. Tags may be displayed for items that are not visible in the same frame as the tag.

Although tags are shown having a lead line that connects the tag text area with an associated item, other tag designs are possible. For example, a line may end in an arrowhead to “point” in the general direction of an associated item. A cartoon bubble with an angled portion that points to an item can be used. If the tag is placed on or near its associated item then a lead line or other directional indicator may not be necessary. In other words, the placement of the tag or text can be an indicator of the associated item. Any suitable, desired or effective type of indicator for associating tag information with an item may be employed. Many other variations of tag characteristics or behavior are possible.

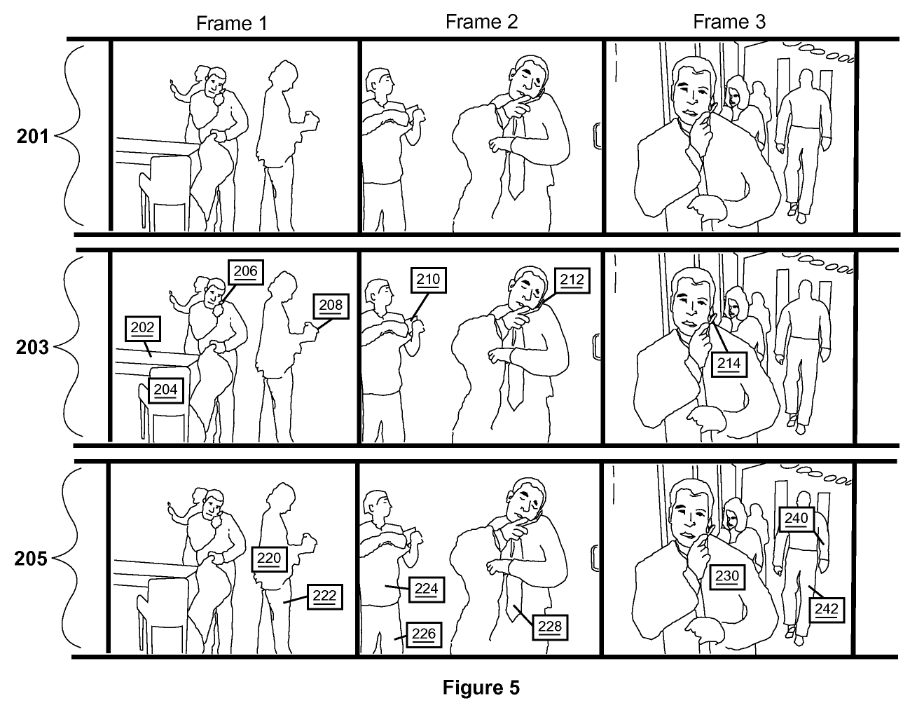

FIG. 5 shows an original sequence and two corresponding tag sequences. In FIG. 5, original sequence 201 is a video clip of a man walking out of a room while talking on a cell phone and putting on a suit jacket. Gadget tag sequence 203 shows the synchronized same clip as original sequence 201 with gadget tags added. Style tag sequence 205 shows the synchronized same clip as original sequence 201 with style tags added.

In gadget tag sequence 203, the first frame of the sequence corresponds with the first frame of original sequence 201. Note that the progression of time is shown as three snapshots along the horizontal axis. As is known in the art, this method of showing video animation on paper uses one or a few “key frames” to show progression of the action. In actuality, the video clip represented by the three key frames would include hundreds of frames displayed over 10-20 seconds. This is only one example of coordinating a visual presentation with tag sequences. Any number and type of frames can be used. Any suitable format, frame resolution, compression, codec, encryption, enhancement, correction, special effects, overlays or other variations can be used. Aspects or features described herein can be adapted for use with any display technology such as three-dimensional renderings, multiple screens, screen sizes and shapes, etc.

Original sequence 201 does not have tags so that a user or viewer that watches the original sequence can view the original program without tags. If, at any time during the sequence, a user selects gadget tag sequence 203, then the display is changed from displaying the original sequence to display a corresponding frame of the gadget tag sequence. In other words, if a user selects the gadget tag sequence at or shortly before presentation of the first frame, then the display is switched to gadget tag sequence 203 at frame one. In frame one of the gadget tag sequence tags 202, 204, 206 and 208 are displayed. These correspond, respectively, to table, chair, cell phone and camera items that are visible in the scene.

Frame two of gadget tag sequence 203 shows personal digital assistant (PDA) tag 210 and cell phone tag 212. Frame three of gadget tag sequence 203 shows cell phone tag 214. Note that the user can selectively switch between the gadget tag and original sequences. For example, if the user decides to view the program without tags while viewing gadget tag sequence 203 at or about frame two then original sequence 201 will begin displaying at the corresponding location (e.g., at or about frame two) in the original clip.

Style tag sequence 205 corresponds with each of the original and gadget tag sequences similar to the manner in which the gadget tag sequence is described, above, to correspond with the original sequence. In frame one of the style tag sequence, shirt tag 220 and pants tag 222 are shown. Note that these tags are not present in gadget tag sequence 203. This is so the user can select a category of tags (either gadget or style) to display independently to prevent too many tags from cluttering the scene. Other frames in the style tag sequence include tags having to do with clothing such as shirt tag 224, pants tag 226 and tie tag 228 in frame two; and suit tag 230, shirt tag 240 and pants tag 242 in frame three.

Note that any number and type of categories can be used. Provision can be made to overlay two or more categories. Other approaches to segregating or filtering tags can be used. Depending upon the capabilities of the playback system, tags can be selected, mixed and filtered. For example, if a user's preferences are known then tags that meet those preferences can be displayed and tags that do not meet those preferences can be prevented from display. A user can enter keywords to use to display tags that match the keywords. For example, “electronics” or “autos” can be used as keywords so that only tags that describe items that match the keywords are displayed. A user might select an option whereby tags that were previously displayed are then prevented from display. Or only tags that were previously displayed can be allowed for display. Any type of approach for selectively displaying tags can be adapted for use with the invention.

Although FIG. 5 illustrates selection of tag categories based on multiple sequences of video, this is not a requirement of an implementation of displaying tags. The next sections of this application present embodiments where separate sequences are used. However, other implementations can use different approaches to achieve the desired effect at the user interface without actually having separate video clips or streams. For example, a computer processor can be used to overlay tags onto video. The tags can be stored as separate graphics together with, or separate from, data that defines the video sequence. Or the tag graphics can be generated by a processor in real time according to predefined rules or definitions. With this approach, only one video sequence—the original video sequence—may be presented as the graphics for the tags are then simply added into the video frames when selected. The positioning of the tags can be by pre-stored coordinates that are associated with frames in the video. Each coordinate set can be associated with a particular tag by using a tag identification (ID) number, tag name or other identification or means. In general, any suitable presentation system can be used to provide the user interface (e.g., display effects and user input processing) of embodiments of the invention.

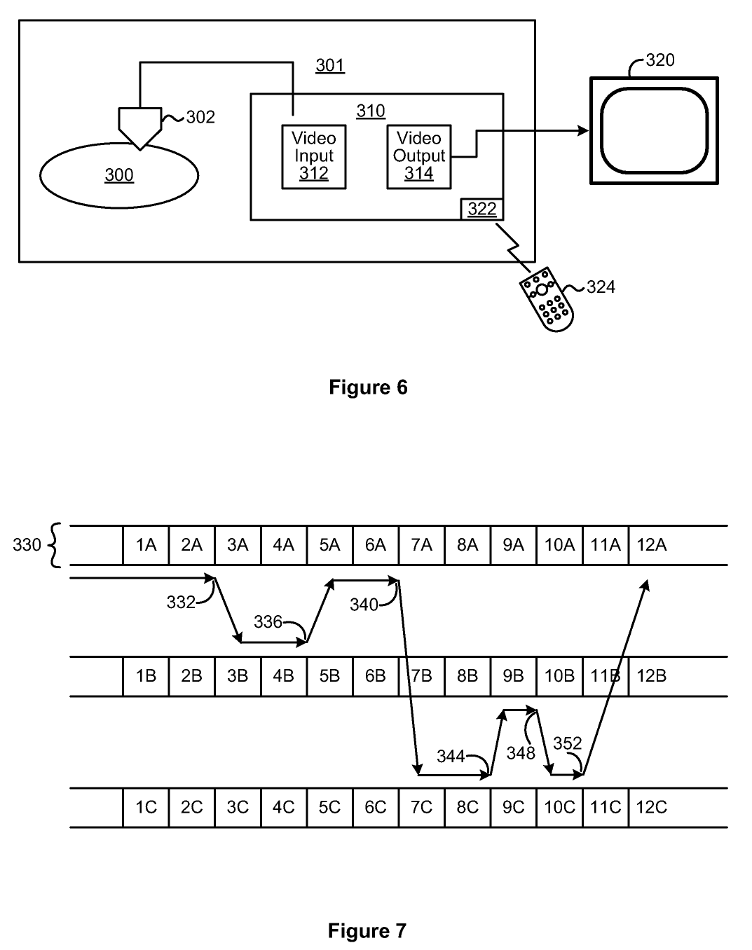

FIG. 6 shows a DVD player system suitable for use with the present invention. Any specific hardware and software described herein are only presented to provide a basic illustration of but one example of components and subsystems that can be used to achieve certain functionality such as playback of a video. It should be apparent that components and processes can be added to, removed from or modified from those shown in the Figures, or described in the text, herein.

In FIG. 6, DVD player 301 plays DVD 300. DVD 300 contains multiple sequences of video information that can be read by optical read head 302. The video information obtained by the read head is transferred for processing by processing system 310. Processing system 310 can include hardware components and software processes such as a central processing unit (CPU) and storage media such as random access memory (RAM), read-only memory (ROM), etc. that include instructions or other definitions for functions to be performed by the hardware. For example, a storage medium can include instructions executable by the CPU. Other resources can be included in processing system 310 such as a hard disk drive or other mass storage, Internet connection, audio processing circuitry and processes, etc. Many variations are possible and many different types of DVD players or other systems for presenting audio/visual content can be used.

Video data is received at video input 312. Video for presentation is processed and output by video output 3 14. The output video is transferred to display 320. The formats for input and output video can be of any suitable type. A user input device such as remote control unit 324 is used to provide user selection information to sensor 322. The sensed information is used to control display of the tags.

FIG. 7 illustrates multiple sequences or streams of video that can be included on a DVD disc. These sequences can be coordinated so that they can be played back in a time-based synchronous manner. One such method of synchronizing multiple video streams is standardized in specifications promulgated by the DVD Format/Logo Licensing Corporation such as “DVD Specifications for Read-Only Disc; Part 3 Video Specifications, Version 1.13, March 2002.” An acceptable method is described in this Specification as “multi-angle” and/or “seamless play.” Such an approach is also described in U.S. Pat. No. 5,734,862. Note that any suitable method that allows selection and display of synchronized video streams can be used.

In FIG. 7, it is assumed that the DVD begins playing on sequence A at 330. Sequence A is, for example, the original video sequence without tags. At a point near the beginning of playing of frame 3A of sequence A the user activates a control (e.g. pressing a button, etc.) to select sequence B at 332. Playback of the video then switches from sequence A to sequence B so that frame 3B is displayed on display 320 instead of frame 3A. Subsequent frames from sequence B are displayed such as frame 4B, et seq.

At a time prior to display of frame 5B, a signal is received from a user input device to select the original sequence A. So frame 5A is then displayed instead of frame 5B. Similarly, a signal causes switching at 340 to display frame 7C from sequence C. Subsequent switching of sequences occurs at 344 to switch to sequence B, at 348 to switch to sequence C and at 352 to switch to sequence A. Sequences B and C can be tag sequences (e.g., Gadget and Style types of tags, respectively) so that FIG. 7 illustrates switching among video sequences in a multi-angle (with optional seamless play) system to achieve the functionality described above in the discussion of FIGS. 1-5.

A broadcast or cable television embodiment can also be used to provide tags in a manner similar to that described above for a DVD player. In a radio-frequency, optical or cable set-top box approach, the multiple streams can be provided on different channels. Instead of reading the video data from an optical disc, the video sequences are obtained from different channels and switching between streams is effected by changing channels. This channel approach is convenient in that it does not require any modification to existing consumer equipment since it relies only on providing specific content on specific channels (e.g., on channels that are adjacent in channel number, for example).

Modification may be made to incorporate multiple sequences in a single channel. For example, if the channel bandwidth is high enough to accommodate two or more streams then a single channel can be used to convey the streams. Separation and selection of the streams can be by a manner that is known in the art.

Other playback or presentation systems are possible. For example, a computer system, iPod™, portable DVD player, PDA, game console, etc. can all be used for video playback and can be provided with functionality to display tags. Where a system includes sufficient resources such as, e.g., a processor and RAM, it is possible to store tags along with maps of when and how to display each tag. The tag maps can be stored as coordinate data with IDs that associate a tag graphic with a location and time of playback. Time of playback can be designated, for example, by a frame number, elapsed time from start of playing, time code from a zero or start time of a sequence, etc. When the time associated with a tag is encountered (and assuming tag mode is selected for playback) then the coordinates are used to display the associated tag's graphic. Other information can be included.

With more sophisticated presentation systems, additional features can be allowed. For example, a user can be allowed to use a pointer to click on or near a tag. The click can result in a hyperlink to additional information such as information at a website. A portion of the additional information (including a website) can be displayed on the display in association with, or in place of, the original or tagged video.

One manner of providing hyperlink data in a limited presentation device is to associate link information with tags. These associations can use a table that is loaded into the presentation device. One simple type of association is to display a number on a tag. A user can then select the number or tag by using the remote control device, keyboard, keypad, pointer, etc. and the information associated with the tag identified by the number can then be presented. For example, if a DVD player detects that the user has chosen freeze-frame to stop the playback of a tagged sequence, and then the user enters a number of a tag on the screen, it can be assumed that the user wishes to obtain more information about that tag. Pre-stored additional information can be displayed on the screen or on another device. Other ways of identifying tags or items to obtain more information about an item are possible.

If a user registers or associates other devices with their name or account, an email can be sent to the other device from a central service. The email can include additional information about the selected item. A web page can be displayed on the same device that is displaying the video or another device can have the web page (or other data) “pushed” to the device to cause a display of the additional information.

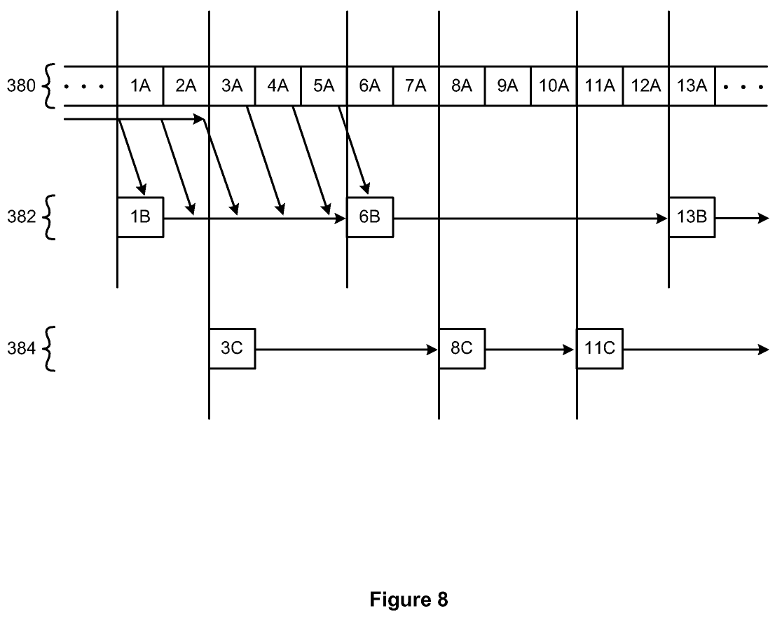

FIG. 8 shows an example of still frame tags. In FIG. 8, sequence 380 is the original video sequence. Sequences 382 and 384 are tag sequences. However, sequences 382 and 384 are not in one-to-one frame correspondence with the original video sequence. Instead, the tag sequences only use one frame to correspond with multiple frames of the video sequence. Depending on the ratio of tag frames to original video frames, much less information needs to be transferred than with the full sequence approach of FIG. 7.

For example, if the number of items remains relatively constant for many seconds in a playback of the original video, a still frame that is representative of the overall image during the un-changing sequence can be used as the frame that is switched to from any point in the un-changing sequence. This is shown in FIG. 8 where selection of sequence 382 during playback times associated with frames 1A-5A causes frame 1B to be displayed. Similarly, frame 6B is displayed if sequence 382 is selected during playback of 6A-12A.

Sequence 384 also has a still-frame tagged sequence so that frame 3C will be displayed if sequence 384 is selected at any time during the display of the original video sequence corresponding to frames 3A-7A. Note that still-frame sequences can be mixed with fully synchronized (i.e., non-still frame) sequences, as desired. Also, the image in the original video sequence need not be un-changing in order to employ still-frame sequences as still-frame sequences can be used with any type of content in the original video sequence.

Still frames such as 1B, 6B, 13B, 3C, 8C and 11C are displayed for the same time interval as the corresponding frames of sequence 380. In other words, if frame 1B is selected at a time just before displaying frame 1A during playback of sequence 380, then frame 1B will be displayed in the interval that would have been occupied by playback of 1A-5A. At the time corresponding to display of frame 6A (had playback remained on sequence 380) frame 6B is displayed. This allows jumping from the original sequence to a still-frame tagged sequence and jumping back to the original sequence while maintaining time-synchronization with the original video. The audio track can remain playing over the display of the still-frame tagged sequence. Alternatively, when jumping from a still-frame tagged sequence back to the original video, the original video sequence can be resumed from the point where it was exited in order to view the tagged sequence. Features discussed above with respect to non-still frame tagged sequences can be applied to still frame tagged sequences.

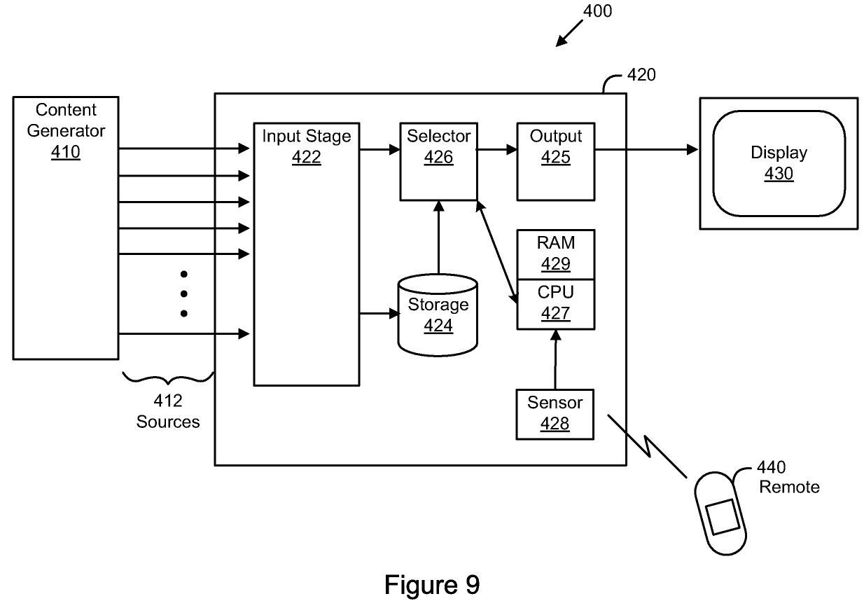

FIG. 9 illustrates a visual presentation system suitable for use with a preferred broadcast, or set-top box, embodiment of the invention. In this preferred embodiment, the presentation system of FIG. 9 is designed to allow a user to switch between either a standard video program or an enhanced version of the standard program. Switching can occur while the program is being viewed without any significant break in the continuity of presentation of the program's images or audio.

In a preferred embodiment, two or more associated video channels are provided substantially simultaneously. However, as discussed in more detail below other ways to synchronize the multiple channels or programs of content are possible. For ease of discussion, a two-channel implementation is first described.

In a two-channel implementation a user is able to select between a display of tags and no display of tags while being able to view substantially continuous program content. The first channel includes a standard, untagged, video program. The second channel includes the same program but includes enhanced information in the form of tags, e.g., added text, graphics, or other symbolic information to overlay the standard video's content. By making a channel switch between the two associated channels, the user is provided with the effect of turning on or off tags in the program content. Additional common features of video playback such as pause, store, step back, step forward, etc. can be provided in an interface with which the typical user is already familiar by maintaining synchronization between the two channels.

In FIG. 9, system 400 includes content generator 410 that provides multiple sources 412. Examples of content sources can include separate channels in a television (TV) broadcast, channels in a cable or satellite television signal, multi-angle digital versatile disc (DVD) playback, etc. Any other suitable content source may be used including mechanisms for storing or transferring content such as a hard disk drive, digital memory, digital network, etc. Other embodiments may not require separate sources but can have information embedded into a single source. A preferred embodiment uses traditional television broadcast distribution (e.g., cable, satellite, terrestrial, etc.) but the features described herein can be applied to other broadcast schemes and such applications are within the scope of the invention unless otherwise noted. For example, digital network multicast or streaming broadcast distribution may be used.

Sources 412 are received at receiver 420. Receiver 420 can be, for example, a set-top box, television receiver, computer system, game console, cell phone, portable electronic device, etc. In the case of a TV receiver or cable set-top box in a broadcast application the content generator can be any device or location farther up the signal chain such as a TV station, head end, modulator, multiplexer, repeater or amplifier, etc. The content generator 410 of FIG. 9 is symbolic of any device or location where content sources are originated, transferred, assembled or processed prior to reception at receiver 420. Any suitable type of communication link (e.g., radio, infrared, wired, wireless, fiber optic, etc.), data format (e.g., digital or analog) or protocol (e.g., those promoted by National Television System Committee (NTSC), Motion Picture Experts Group (MPEG), etc.) or other type or arrangement of information or transfer method can be used.

Receiver 420 includes input stage 422 for receiving multiple sources. Input stage 422 provides source content to either selector 426 or storage 424. Storage 424 provides previously stored content to selector 426. Note that although a single line is shown among various components in receiver 420, that each line can represent one or more content sources being transferred at the same or different times. Duplicate copies of a content source signal can be transferred along a line at the same or overlapping times. Further other designs can vary from that shown in FIG. 9 by changing the data paths or by changing the number and type of components. For example, an alternative design may have all of the content passing through storage 424 before being output to selector 426. Yet another design may not have any storage component at all. The particular receiver shown in FIG. 9 is an example of a set-top box with digital video recording (DVR) capability such as those provided by DirecTV™, or Comcast™and manufactured by, e.g., Motorola™, TiVO™, and others. In the set-top box example, the input stage can be a tuner that includes other circuitry for decoding signals.

Selector 426 acts in response to sensor 428 to provide a selected source signal to output 425 for presentation on display 430 in response to a user input from remote control 440. Although the invention is described primarily with respect to a television remote control system as a user input device, any other suitable user input device can be employed. For example, a mouse or other pointing device can be used to select an on-screen control. Other input devices can include a keyboard, cell phone button pad, dedicated controller (optionally having buttons, knobs, slider controls, etc.), voice recognition unit, image recognition, motion or gesture detection, etc. In general, any suitable input system can be used to generate a select signal for use by the selector to choose a content source for display. In other embodiments, the select signal can be automatically generated rather than coming directly from a user. For example, a select signal can be provided from the Internet, embedded or associated with one or more content source signals, stored on storage 424, etc. A select signal can originate from an external device or system so that a third party entity or device can control whether enhanced video is presented.

Output 425 can be a simple physical connector or jack for a hardwired or optical fiber cable. Output 425 can also include a wireless transmitter for sending content source signals or images derived from the signals to a display device. Output 425 can include further signal processing such as compression, encoding, etc. In general, any type of information transfer can be used to implement the data paths shown in FIG. 9, including the data path from output 425 to display 430.

Receiver 420 can include various resources to achieve desired functionality. Examples of resources such as processor 427 and random-access memory 429 are shown in FIG. 9. The amount and type of resources can vary among embodiments. Depending upon the functionality desired, more or less resources can be used in a design for a receiver. Additional resources can be included such as an Internet connection, removable storage connection, security systems, wireless transceiver, etc.

Using the system of FIG. 9, a user can select whether to watch a standard video (e.g., a video without tags or other graphic overlays) or an enhanced version of the same video that includes additional or different information related to the standard video. For example, tags and graphics can be included in the enhanced version of the standard video so that products or items in a scene can be described to include a model or make of the item, price, way to purchase the item, etc. Participants in a sporting event can be identified by text that can provide statistics of their performance. The standard and enhanced versions of the video use the same underlying content and are synchronized so that when the user presses a button on the remote control the standard video is replaced with the enhanced video to give the effect of additional information overlaying the continuously-playing standard version of the content. Depending on how fast the selection and switching of content can be accomplished this can appear as an instant and seamless transition to the viewer. Continuity of both audio and images can be maintained, as desired.

Although it is desirable to perform the switching “seamlessly” and within a time period that is not detectable to a human eye, lesser levels of performance that result in a noticeable change or discontinuity of a sequence of displayed images may still be acceptable as long as overall presentation continuity is maintained. In some cases, such a discontinuity may be desirable. For example, when a viewer selects the enhanced video while watching the standard video it may be desirable for the enhanced video to be presented at a time just before the user selection. For example, the enhanced video can be played starting at a time 1-2 seconds prior to a corresponding point in the standard video that was displayed at the time of user selection. This can provide the user with a “lead-in” period to ensure that an item about which the user seeks additional (enhanced) information will appear on the screen in the enhanced mode.

A preferred embodiment uses standard and enhanced modes to display “untagged” and “tagged” video, respectively. Tags can be used similarly to the tags described in the priority parent patent application referenced, above. In a preferred embodiment a tag can include text or graphics and can include a pointer to associate the text or graphic to an item in a scene of video. A pointer can be a line or other indicator that is drawn from the tag text or graphic to connect, point to, or end near an item to which the tag text or graphic refers or is associated. Tag association with an item can also be by placing the tag on top of or in proximity to an item. Other types of tags or information do not need to be associated with a specific (or any) item.

Tag designs can vary and can use any suitable design property. Usually it is desirable to have the tags be legible and convey a desired amount of information while at the same time being as unobtrusive as possible so that viewing of the basic video content is still possible. Different graphics approaches such as using colors that are compatible with the scene yet provide sufficient contrast, using transparent or semi-transparent windows, etc. can be employed. Tag placement can be chosen so that the tag overlays areas of the video that are less important to viewing. For example, a blank wall could be a good placement of a tag while an area over a character's face would usually not be a good placement.

Tag shape, color, position, animation and size are some of the tag characteristics that can be modified. Many different factors can affect these tag characteristics. If a specific factor, such as aesthetics, is given priority then a graphic artist or scene coordinator can be used to match the look and behavior of tags to a theme of a scene or overall presentation. For example, where a scary movie is tagged, the tag design can be in darker colors with borders having cobwebs, blood, ritual symbols, etc. For a science fiction episode, the tags can be made to look futuristic.

If an advertising factor is given priority then tags from a preferred sponsor (e.g., someone who is paying more for advertising) can be presented in bolder text, brighter colors, made larger or made to overlap on top of other tags, etc.

In general, any of the tag characteristics can be modified in accordance with one or more factors.

As the scene changes, such as when characters or objects move through or within a scene, when the camera changes angles, when there is a cut to another scene, etc., tags can also change according to a tag behavior. Different tag behaviors can be used to achieve objectives of conveying information associated with an item while still allowing viewing of the video. One behavior is to minimize the movement of a tag's text while still allowing the tag to “point” to the item. This can be accomplished by keeping the tag's text stationary with one end of the lead line connecting to the text box and the other end following a moving item to which the text relates.

Another tag behavior is to shrink or enlarge a tag's text box according to the relative size of the item associated with the tag. For example, if an item is in the foreground then the tag's text area can be larger. As the item moves farther from the camera and becomes smaller then the tag can become smaller and can eventually be removed from the screen. The manner of shrinking the text area can include making the actual text smaller, removing text from the display while retaining other text, replacing the text with alternative text, etc. Tags may be displayed for items that are not visible in the same frame as the tag.

Although tags are shown having a lead line that connects the tag text area with an associated item, other tag designs are possible. For example, a line may end in an arrowhead to “point” in the general direction of an associated item. A cartoon bubble with an angled portion that points to an item can be used. If the tag is placed on or near its associated item then a lead line or other directional indicator may not be necessary. In other words, the placement of the tag or text can be an indicator of the associated item. Any suitable, desired or effective type of indicator for associating tag information with an item may be employed. Many other variations of tag characteristics or behavior are possible.

FIG. 2 will now be returned to in order to provide further details of turning tags on or off in a set-top box application. FIG. 2 shows an original sequence (standard video) and two corresponding tag sequences (enhanced video). In a broadcast television/set-top box application original sequence 201 is standard video broadcast on a first channel, say, channel 201. Gadget tag sequence 203 is enhanced video broadcast on a second channel, channel 203. If the channel 201 and channel 203 video contents are broadcast approximately simultaneously (i.e., in time-synchronization) so that the frames of the underlying content are matched (as shown graphically in FIG. 2) then a user can switch between channels 201 and 203 using traditional or new methods, to make the tags either appear or disappear.

Sequence 205 corresponds to a third channel 205. This third channel is used to provide additional tags that might otherwise result in an overly cluttered tag view mode. In a preferred embodiment, tags are separated into two categories so that channel 203's content shows tags for “gadgets” or consumer electronic items while channel 205's content shows tags for “style” or clothing, jewelry and other fashion types of items. Any number of channels showing any number and type of tags can be employed. One approach allows a hierarchy of detail to be provided as where a first tag channel includes a basic level of detail such as brand and model; while a second channel can show price, purchasing location, website address, etc.

Note that any number and type of categories can be used. Provision can be made to overlay two or more categories. Other approaches to segregate or filter tags can be used. Depending upon the capabilities of the playback system, tags can be selected, mixed and filtered. For example, if a user's preferences are known then tags that meet those preferences can be displayed and tags that do not meet those preferences can be prevented from display. A user can enter keywords to use to display tags that match the keywords. For example, “electronics” or “autos” can be used as keywords so that only tags that describe items that match the keywords are displayed. A user might select an option whereby tags that were previously displayed are then prevented from display. Or only tags that were previously displayed can be allowed for display. Any type of approach for selectively displaying tags can be adapted for use with the invention.

Other types of synchronization mechanisms can be used rather than time-based synchronization as described above. For example, two or more sets of content (e.g., standard and enhanced versions) can be location-based synchronized by storing the channels, files, streams or other versions of the content on a fixed medium such as an optical or magnetic disk, solid-state memory, etc. The locations of each portion of the content (e.g., packets, frames, blocks, groups of blocks, etc.) can be correlated so that same-content frames among the different content can be identified by location. In this manner when a portion of a first content is presented to a viewer and the viewer chooses to switch content, the corresponding location of the second content is used to retrieve the second content associated with the first content's portion is displayed so that a continuous presentation is maintained.

Code-based synchronization can be used. A time code such as that provided by various standards such as SMPTE, MPEG, etc. can be used either embedded into, or otherwise associated with, the content. If a synchronization point is known between two content data streams then at a point of switching from a first content to a second content the second content will be displayed at a point corresponding with the first content as determined by the time coding. For example, if standard and enhanced content are switched then a map (e.g. table of correlated addresses), index, number derived from a calculation, etc. can be used to determine a frame or portion from the enhanced content that corresponds to the first content and vice versa. In general, any suitable method of synchronization can be used, as desired.

By using location or code synchronization it is possible to store one or more associated content files in a set-top box, computer, cell phone, game system, or other device and play back the content at a later time while still maintaining synchronization so that correlated content switching can occur to achieve the effect of turning tag display on or off while maintaining a continuous presentation of the standard content. One approach records two or more channels at the same time onto a storage medium in a set-top box. When presentation of one of the channels occurs from the stored version of the channel, the other stored associated channels are accessed when the viewer selects a tag view mode. In other embodiments, one version of the content (e.g., standard), can be broadcast and played back in live time or in a time-shifted manner, while other versions (e.g., enhanced or tagged) versions of the content can be pre-stored at a local or remote storage device and synchronized with the currently viewed content when a viewer elects to switch the content (e.g., from a non-tagged mode to a tagged mode). By using different types of synchronization it is possible to implement several different embodiments where two or more associated types of content can be played and switched among regardless of when the content was transferred or where the content has been stored.

One embodiment uses a digital video recorder to allow a user to store content, and to step backward or forward during playback of stored content or to otherwise manipulate playback. In applications where there are two or more associated versions of the content (e.g., in two or more separate channels), then upon detecting that a first content is being stored in the DVR each associated content is also stored. This is necessary so that when the first content is played back from storage and it is desired to switch from the first content to associated content that the associated content will also be available for immediate playback.

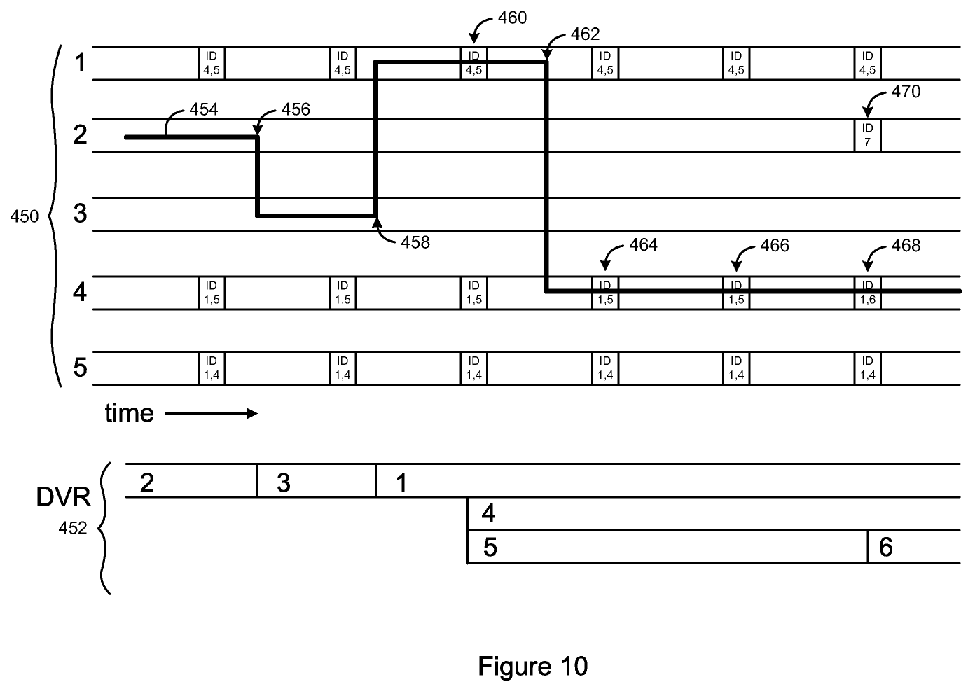

In a preferred embodiment, internal content identifiers are used to determine when a primary content has additional associated content. FIG. 10 illustrates five content streams at 450 numbered 1-5. In a broadcast, set-top box application these streams can be separate channels. In other embodiments the streams can be other forms of analog or digital streams, files, etc.

Thick line 454 shows the channel that is currently selected and displayed to a human viewer or user. At the left, or starting point, of FIG. 10, channel 2 is displayed for a period of time up to time 456. At time 456 the channel is switched by user selection to channel 3.

DVR 452 records the selected channel as is known in the art. For example, some forms of DVR recording can be user-selected and others can be automatic. A user can turn DVR recording of a channel on or off, but typically a set-top box is always recording at least a recent portion of the currently viewed channel so that a user can step back in recent time while watching a program. If the user has not selected recording, the automatically recorded current channel's content may be “unstored” (e.g., deleted, marked for deletion, removed from menu selection, or otherwise made unavailable to a user) after a short period of time, when the user switches to another channel, or upon another event or condition.

DVRs record channels that are not currently being displayed as, for example, when a user schedules a recording of a program that will be broadcast later. Another common DVR feature allows a user to switch to a new channel and then step back in time on the new channel even to a point before the switch. The system can provide the pre-switch content for a current newly-switched channel by loading and storing the pre-switch content as the viewer watches the “live” content (i.e., content that is displayed at about the same time it is received) or before the user switches to the new channel. Many other recording variations are possible and may be employed with the present invention. In general, simultaneous channel storing as described herein (e.g., in connection with FIG. 10) includes any method of identifying and storing content from additional channels that are associated with a current channel being viewed. In other embodiments the content need not be conveyed by channels but can be conveyed to a receiving system by any other suitable mechanism.

As shown in FIG. 10, DVR 452 records channel 2 up until time 456 when channel 3 has been selected. At this time DVR 452 begins recording channel 3, the currently viewed channel. As long as the user stays on channel 3, the user can step back in the recording up until the time 456. Typical DVR implementations would not permit the user to step back past time 456 to watch earlier portions of channel 3 content, or to watch previously stored channel 2 content. However, such permissions or variations are possible in different embodiments, as desired.

At time 458, the user switches from channel 3 to channel 1. Channel 1 is provided with embedded channel identifiers to identify other channels that are associated with channel 1. At regular intervals identifiers such as 460 are included in the stream of channel 1. These identifiers can be included in a vertical or horizontal blank interval, embedded within a frame, block, header, or other location. The identifiers need not be at regular intervals but can be irregularly spaced and can occur infrequently or even only once (e.g., at the beginning of a stream). In general, the internal embedded identifiers can be implemented in any suitable format. As discussed below, external forms of identifiers can be used which do not require embedded identifiers—or which can be used in concert with internal identifiers.

At time 458 when channel 1 is selected DVR 452 records the content from channel 1. When ID 460 is encountered in channel's content it indicates that channels 4 and 5 are associated with channel 1. At approximately this point in time DVR 452 begins recording the associated channel content on channels 4 and 5 so that all three associated channels 1, 4 and 5 are recorded. The associated channels can be, for example, a standard video and first and second tagged versions of the video. This allows a user to perform forward, reverse, pause, store, etc. functions on the channel 1 content while still preserving the ability to select enhanced versions of the content as described above.

At time 462, the user selects channel 4. Since channel 4 is within the associated group of 1, 4 and 5, recording continues of the three channels in the last defined group according to identifier 460. Next, identifier 464 in channel 4's content is encountered. This identifier defines channels 1 and 5 as being associated with channel 4. Thus, the group of 1, 4 and 5 is still maintained and recording of these three channels continues. Identifier 466 is encountered which defines the same associated group of 1, 4 and 5.

Upon encountering identifier 468 in channel 4, a new group of channels 1, 4 and 6 is defined since identifier 468 names channels 1 and 6 as associated with channel 4. Thus, content from channel 6 (not shown in FIG. 10) is recorded on DVR 452's storage in place of channel 5. Recording can similarly proceed for any length of time among any number of associated or non-associated channels. It should be apparent that the types of associations can change, as desired. Any number of associated channels can be named in an identifier. Identifier 470 illustrates that a channel may not have any identifiers for a long time before an identifier is encountered in the channel's stream. Streams such as that from channel 3 may never have any identifier.

The inclusion of identifiers to associate channels with one another can be performed at any point in the creation, transfer or processing of the content. For example, an identifier can be placed in a video program during production of the video, during post-production, upon storing the video program, prior to or during broadcasting, at a time of repeating the broadcast signal for re-transmission, within a set-top box or other playback device, etc. Internal identifiers can be embedded into the video content. Examples of internal identifiers include identification information that is pre-pended or appended to headers, packets, sections, segments, frames, blocks, pictures or other portions of data or a data stream that is used to represent or convey the content. External identifiers can use ID numbers, tables, maps, indexes, pointers or other data structures to associate primary content with secondary content. Such identification can use information about the contents'delivery mechanisms (e.g., channels, streams, Internet Protocol flow, etc.) or can use any other suitable manner of association.

Secondary channels that are associated with a first, or primary, channel can be associated with the primary channel at any point in the creation or delivery of the first channel. For example, the associated channels can be associated with the primary channel at a time of initial recording or creation of the primary channel's content. Such associations can also be made at a later time such as when a signal that includes the first channel or content is received at a head end, station, sub-station, local distribution center, etc. The association can even be made at a time of a user selecting or viewing the primary content as, for example, where the secondary content is available locally or over a network prior to, or at, a time of viewing of the primary content. Using a local distribution site to perform the association may provide more unused channels or bandwidth for the secondary channels and can also allow inclusion of information that is more relevant to a specific geographic area or demographic.

It should be apparent that features disclosed herein may be used independently of other features. For example, any type of tags or other information may be inserted into or associated with content according to embodiments of the invention rather than just the specific types of tags presented in this specification.

Generation or recording of associated channels can be combined with other features described herein. For example, still frame versions of content (as described, for example, in connection with FIG. 8) can be stored in place of full-motion video in order to save storage space when recording or transmitting the associated channels.

Methods or apparatus for displaying, authoring, selecting, recording or synchronizing channels, streams or other forms of content can be used independently of other features. Other variations are possible that are within the scope of the invention rather than just the specific embodiments disclosed herein.

Tags or other information can be associated at any point in the creation or delivery of content. One embodiment allows insertion of tags into “live” or “real time” broadcast of, for example, sporting events. By delaying the broadcast of the actual live content on a first channel, either automated or manual (or a combination) approaches can be used to define tag placement and a second channel that includes the tags can then be transmitted at the same time (i.e., time-synchronization) of as transmitting of the first channel.

Any suitable programming language can be used to implement features of the present invention including, e.g., C, C++, Java, PL/I, assembly language, etc. Different programming techniques can be employed such as procedural or object oriented. The routines can execute on a single processing device or multiple processors. The order of operations described herein can be changed. Multiple steps can be performed at the same time. The flowchart sequence can be interrupted. The routines can operate in an operating system environment or as stand-alone routines occupying all, or a substantial part, of the system processing.

Steps can be performed in any order by hardware or software, as desired. Note that steps can be added to, taken from or modified from the steps in the flowcharts presented in this specification without deviating from the scope of the invention. In general, the flowcharts are only used to indicate one possible sequence of basic operations to achieve a function.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

As used herein the various databases, application software or network tools may reside in one or more server computers and more particularly, in the memory of such server computers. As used herein, “memory” for purposes of embodiments of the present invention may be any medium that can contain, store, communicate, propagate, or transport the program for use by or in connection with the instruction execution system, apparatus, system or device. The memory can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment,” “an embodiment,” or “a specific embodiment” means that a particular feature, structure, or characteristic described in connection with the embodiment is included in at least one embodiment of the present invention and not necessarily in all embodiments. Thus, respective appearances of the phrases “in one embodiment,” “in an embodiment,” or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for recording multiple associated channels of video content, the method comprising:
accepting a signal from a user input device to select a first channel of first video content;
determining that a second channel having second video content is associated with the first channel;
detecting a signal to store the first video content; and
storing the first and second video content in response to the signal to store the first video content.

2. The method of claim 1, wherein determining includes:
detecting an identifier associated with the first content, wherein the identifier identifies the second content as associated with the first content.

3. The method of claim 2, wherein the identifier is internal to the first content.

4. The method of claim 2, wherein the identifier is external to the first and second content.

5. The method of claim 1, wherein storing includes storing the content on a storage medium residing locally to a display that is used to present the first and second content to a user.

6. The method of claim 1, wherein storing includes storing the content on a storage medium residing remotely from a display that is used to present the first and second content to a user.

7. The method of claim 1, wherein a channel comprises a frequency interval.

8. The method of claim 1, wherein a channel comprises a digital stream over a network.

9. An apparatus for recording multiple associated channels of video content, the apparatus comprising:
a processor;
a machine-readable storage medium including instructions executable by the processor for
accepting a signal from a user input device to select a first channel of first video content;
determining that a second channel having second video content is associated with the first channel;
detecting a signal to store the first video content; and
storing the first and second video content in response to the signal to store the first video content.

10. A machine-readable storage medium including instructions executable by a processor for
accepting a signal from a user input device to select a first channel of first video content;
determining that a second channel having second video content is associated with the first channel;
detecting a signal to store the first video content; and
storing the first and second video content in response to the signal to store the first video content.
